(19) United States
(12) Patent Application Publication
(10) Pub. No.: US 2026/0094136 A1
(43) Pub. Date: Apr. 2, 2026

(54) ACCOUNT-LEVEL CONTROL OF GAME CURRENCIES AND EXCHANGES

(71) Applicant: Wells Fargo Bank, N.A., San Francisco, CA (US)

(72) Inventors: Spencer McCoy Alexander, Charlotte, NC (US); Matthew Tyler Hord, Stanley, NC (US); Andrea Renee Leighton, San Francisco, CA (US); Lucy Xi Zhang, Walnut Creek, CA (US)

(21) Appl. No.: 18/903,883

(22) Filed: Oct. 1, 2024

(51) Int. Cl. G06Q 20/10; G06Q 20/22; G06Q 20/24

(52) U.S. Cl. CPC G06Q 20/10; G06Q 20/2295; G06Q 20/24

(57) ABSTRACT

Various systems and methods for managing account-level control of game currencies and exchanges are described herein. A system for processing a transaction for a gaming deposit account at an issuing bank is configured to receive, from a payment network, an approval request message for a transaction related to an in-game asset; evaluate rules established by an accountholder of the gaming deposit account to approve or deny the approval request message, wherein the transaction includes a gaming platform identifier, a game identifier, or an in-game asset identifier, and wherein the rules to evaluate whether to approve or deny the approval request message are based on the gaming platform identifier, the game identifier, or the in-game asset identifier; and complete the transaction using the gaming deposit account when the approval request message is approved.

### BACKGROUND

Online gaming has become a multi-billion-dollar industry. Game developers generate revenue through game sales, expansion pack sales, in-app purchases, branded merchandising, social media, in-app advertising, and the like. In-app purchases provide a mechanism for a game player to purchase game assets with real-world money.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flowchart illustrating a process for establishing a gaming deposit account, according to an embodiment;

FIG. 3 is an example user interface of an application used to configure rules, according to an embodiment;

FIG. 4 is a flowchart illustrating a process for establishing a relationship between a gaming platform and a gaming deposit account, according to an embodiment;

FIG. 5 is a flowchart illustrating a process for processing a transaction from a gaming platform with a gaming deposit account, according to an embodiment;

FIG. 6 is a flowchart illustrating a method for processing a transaction for a gaming deposit account at an issuing bank, according to an embodiment; and

FIG. 7 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide a secure, authorized, and flexible platform for funding in-game purchases. In an embodiment, a system is configured to manage in-game currency for minors through bank escrow accounts. The system enables parents to fund a bank escrow account that children (or other dependents) can access within various games to purchase credits, skins, power boosts, unlocks, or other proprietary game components. The bank escrow account is referred to as a “gaming deposit account. ” The system includes mechanisms for converting funds into game-specific currencies, purchasing and depositing credits into the game account, and implementing parental controls on usage of the escrow account. Additionally, the system supports integration with various rewards programs and auto-refill functionalities based on exchange rate fluctuations. For instance, parents can deposit funds into a bank escrow account that is accessible by one or more dependents (e.g., children). The dependents can access the escrow account from various games to purchase proprietary game currencies.

The present systems and methods described here add a new and useful mechanism to manage funds for children or other dependents that play games and pay for game assets. By directly coupling the gaming deposit account with one or more game platforms, the customer appreciates more security, transactional transparency, and financial education. The providers, both the financial account provider and the game system provider, are given more opportunity to track consumer habits, incentivize consumer spending, and build relationships with commercial partners. The system includes 1) infrastructure to provide a gaming deposit account for converting real-world funds into game-specific currencies, 2) mechanisms for depositing sales proceeds from in-game items back into the gaming deposit account; 3) mechanisms for parental controls for restricting account usage to specific games, gaming companies, or platforms; 4) mechanisms for alerts and notifications for transactions to ensure transparency and education around spending; 5) infrastructure to provide integration with reward programs to convert rewards points earned by using the gaming deposit account into gaming currencies; and 6) mechanisms for auto-refill functionalities, which may be triggered based on exchange rate changes. The present systems and methods incorporate these components into a practical application available for financial institutions, financial customers, gaming users, and gaming businesses. These functions and others are described in more detail below.

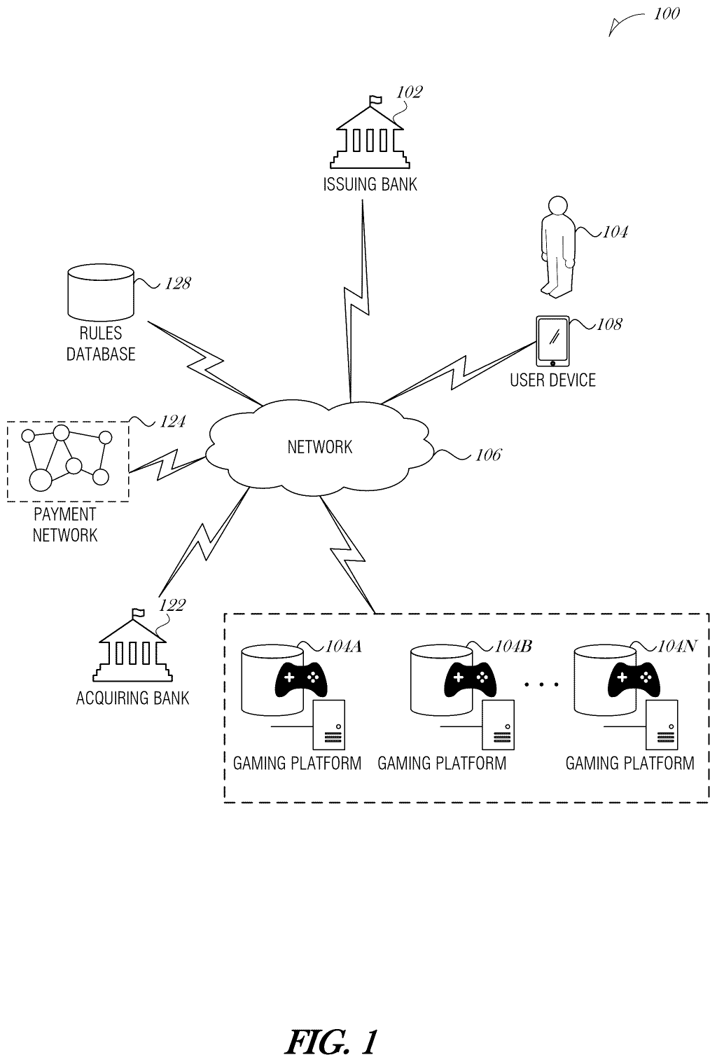

FIG. 1 is a diagram illustrating an operating environment 100, according to an embodiment. In the environment illustrated in FIG. 1, an issuing bank 102 provides financial products to a user 104, such as a gaming deposit account, a checking account, a savings account, a mortgage, a credit card account, or the like. The user 104 (who may also be referred to as a customer, accountholder, cardholder, client, etc. in other contexts), may use online tools to manage financial products by, for instance, accessing a network 106 with a user device 108 to deposit, withdraw, or transfer funds between accounts, add or modify rules that manage accounts, add or modify authorized users to accounts, add or modify authorized payees of the accounts, and the like. The user device 108 may be of any type of compute device including, but not limited to a mobile device, a desktop computer, a smartphone, a laptop computer, a tablet device, a personal digital assistant, a wearable device (e.g., a smartwatch), or the like. The user device 108 may execute an application (app) provided by the issuing bank 102 to access the accounts and perform tasks.

The network 106 may include one or more of local-area networks (LAN), wide-area networks (WAN), wireless networks (e.g., 802.11 or cellular network), the Public Switched Telephone Network (PSTN) network, ad hoc networks, cellular, personal area or peer-to-peer networks (e.g., Bluetooth®, Wi-Fi Direct), or other combinations or permutations of network protocols and network types. The network 106 may include a single local area network (LAN) or wide-area network (WAN), or combinations of LANs or WANs, such as the Internet.

One or more gaming platforms 110A, 110B, . . . , 110N (collectively referred to as 114) are coupled to the network 106. Gaming platforms 110 (e.g., Microsoft® Xbox®, Nintendo® Switch®, Apple® iOS®, Sony® Playstation®, Steam® by Valve®, Battle. net® by Blizzard Entertainment, Inc., Daybreak Game Company, Epic Games, etc.) provide a user 104 access one or more online games (e.g., Minecraft®, Call of Duty, Fortnite, Roblox, EverQuest®, etc.). The games may be developed by the gaming platform 110 or by a separate game developer. For example, the Steam® platform provides a common interface for players to purchase games from various developers, purchase in-game assets, expansion packs, and other downloadable content (DLC) for the games offered on the platform. The gaming platform 110 acts as the intermediary for the game developers and the players. As such, for the purposes of this description, game developers are considered as being combined with one or more gaming platforms 110.

Many online games implement in-game purchases to increase game revenue. In-game purchases allow a player 112 to purchase an in-game asset for real world money. In-game assets include, but are not limited to in-game currency, avatars, treasure chests, weapons, armor, power-ups, skins, vehicles, expansion packs, seasons, downloadable content, and the like. To purchase in-game assets, the player 112 may select an item for purchase and navigate to a checkout process. The checkout process may be provided within the game environment or may be provided in a separate environment (e.g., in a website for the gaming platform 110). Typically, the player 112 may purchase in-game assets using a variety of funding sources, such as a credit card or an online payment system (e.g., PayPal). In the present systems, the player 112 is provided a mechanism to pay for in-game purchases using a dedicated gaming deposit account. The gaming deposit account is issued by the issuing bank 102 to the user 104 and made available to the player 112. In some instances, the user 104 is also the player 112. In other situations, the user 104 is a parent, guardian, or other person having the responsibility for, or legal custody of, the player 112.

When a purchase occurs, the player 112 initiates a transaction between the gaming platform 110 and the issuing bank 102. One or more payment networks 114 (e.g., Visa, Mastercard, Amex, Discover, Zelle, etc.), which are coupled to the network 106, are used to complete the transaction. Payment networks 114 include secure communications networks to act as an intermediary, routing transaction information for a purchase to the issuing bank 102 for approval or denial, and then handling the transfer of funds from the issuing bank 102 to an acquiring bank 116 of the gaming platform 110. Although only one acquiring bank 116 is illustrated in FIG. 1, it is understood that each gaming platform 110 may use one or more acquiring banks 116, and in some cases, all of the gaming platforms 110 may use the same acquiring bank 116.

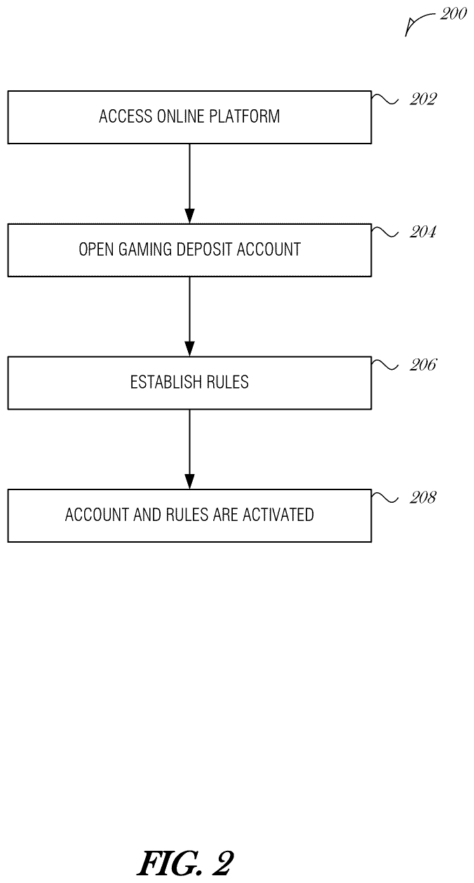

The user 104 can manage the gaming deposit account for the player 112. The user 104 can select for which gaming platforms 110 the player 112 can use the gaming deposit account. The user 104 may also be able to configure or control other features of the gaming deposit account including which gaming platforms 110 are authorized to access the gaming deposit account, an amount of money that a gaming platform 110 may withdraw in a period (e.g., $500 per day limit), frequency of withdrawals (e.g., two purchases a week limit), automatic deposits to fund the gaming deposit account (e.g., a weekly allowance that is deposited into the gaming deposit account), and the like. Although one player 112 and one user 104 are illustrated in FIG. 1, it is understood that a user 104 may be responsible for more than one player 112, and each player 112 may have a separate gaming deposit account at the issuing bank 102. Alternatively, multiple players 112 may share the same gaming deposit account. Various transactions are discussed further in FIGS. 2-4 below.

The user 104 can configure the gaming deposit account with one or more rules. The rules may be defined using the issuing bank's application on the user device 108 and stored in a rules database 118. The rules may be used to define allowable gaming platforms, game developers, or games, withdrawal rules, deposit rules, notification rules, in-game asset type, authorized users, and the like. The rules may be based on the amount of the transaction, the type of merchant (e.g., the merchant category code (MCC) established by the International Organization for Standardization (ISO)), the name of the merchant, the name of the product being purchased, the day or time of the transaction, the frequency of transactions, or other factors.

FIG. 2 is a flowchart illustrating a process 200 for establishing a gaming deposit account, according to an embodiment. At 202, a principal user can use a user device (e.g., a laptop or smartphone) to access an online platform of a financial institution (e.g., bank). In some cases, it may be a prerequisite to have another account at an issuing bank before establishing a gaming deposit account. In such a situation, the principal user may already have a financial account at the issuing bank. In other situations, a gaming deposit account may be a separate financial product that is available without other financial products. As such, instead of an app provided by the issuing bank, the principal user may access a financial institution's public online presence (e.g., a website).

At 204, the principal user can interact electronically with the issuing bank to open a gaming deposit account. The principal user provides at least information identifying the principal user. Optionally, one or more a beneficiary users may be identified and recorded as being able to access the gaming deposit account.

At 206, after the gaming deposit account is opened, the principal user may establish one or more rules. Rules associated with the gaming deposit account are stored in a rules database. Rules may be used to establish allowable gaming platforms, game developers, or games, withdrawal rules, deposit rules, notification rules, in-game asset type, authorized users, and the like. The rules may be based on the amount of the transaction, the type of merchant (e.g., the merchant category code (MCC) established by the International Organization for Standardization (ISO)), the name of the merchant, the name of the product being purchased, the day or time of the transaction, the frequency of transactions, or other factors.

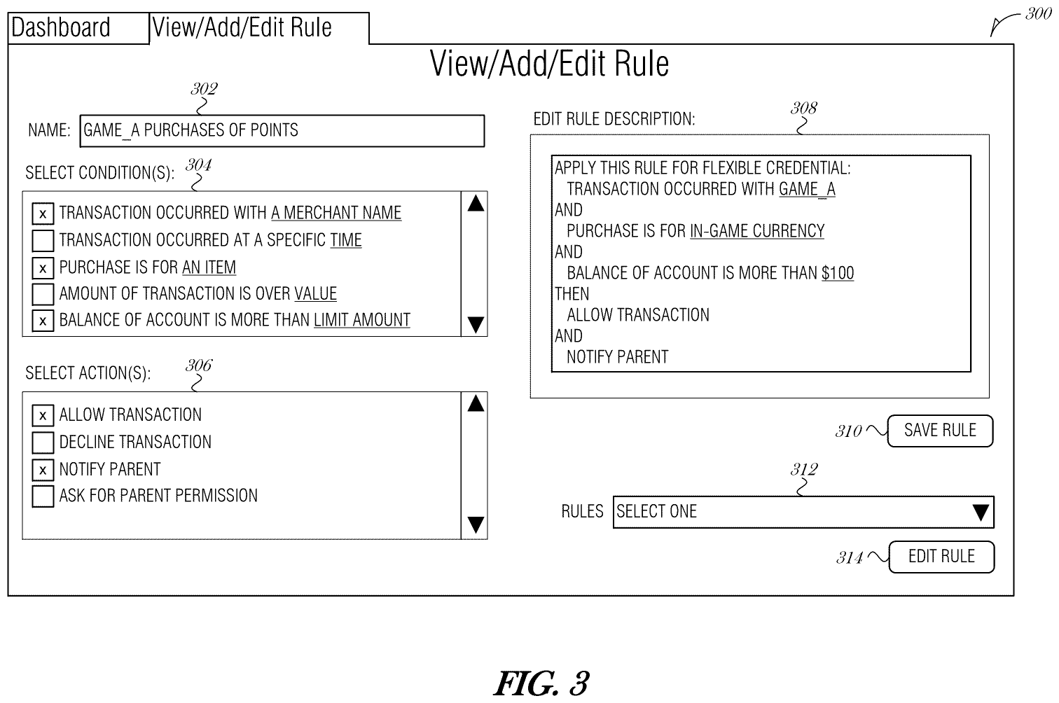

FIG. 3 is an example user interface 300 of an application used to configure rules, according to an embodiment. To add a new rule, a user may provide a name for the rule in a rule name text input control 302. Then the user may select one or more conditions from the conditions control 304. The conditions listed in the condition selection control 304 are merely examples. More or fewer conditions may be implemented. The user may then select one or more actions from the action selection control 306.

When a user selects a condition from the condition selection control 304, the condition is added to the rule description 308. Similarly, when the user selects an action from the action selection control 306, the corresponding action is added to the rule description 308. In the rule description 308, the user may further define the condition or the action. In the example illustrated in FIG. 3, the conditions and actions include underlined portions. These underlined portions indicate the configurable portion of the rule. For instance, when the user selects the condition about the “merchant name,” a popup window or other user interface may be provided to the user to select or input the name of the game developer or gaming platform to use in the condition. Similarly, when the user selects the item type and the account balance conditions, user interfaces may be presented to the user to input an item type (e.g., in-game currency, expansion packs, in-game items, etc.) and a currency amount (e.g., $100).

Further, in the example illustrated in FIG. 3, the user has selected two actions, first to allow the transaction if the conditions are met and second to notify the parent (or other authorized user or accountholder) of the transaction. Once the user has the rule defined, the save button 310 is used to save the rule's settings.

It is understood that a wide range of conditions and actions may be implemented to provide fine-tuned control over the usage of the account. For instance, the parent may enforce an approval process for transactions of particular types or of particular values, the parent may use date ranges to control when the account user is able to conduct transactions with gaming platforms, the parent may use constraints to control the number of transactions allowed in a given period (e.g., “ten purchases per month”, “four purchases per week”, etc.), or other types of control.

The parent may also establish rules that perform operations on the gaming deposit account, such as operations that transfer funds into or out of the account, operations that activate or deactivate authorized users of the account, operations that activate or deactivate use of the account, or the like. In an embodiment, the parent can create a rule for an auto-refill or automatic replenishment of funds in the gaming deposit account. The automatic funding may be based on various conditions, such as a favorable exchange rate, an account balance less than a threshold amount (e.g., less than $20), a time or day (e.g., to reflect a weekly allowance for a child or a birthday present), or the like.

To edit an existing rule, the user may use the select rule dropdown control 312 to select a rule and then when the user presses the edit button 314, the rule and its details are displayed in the rule name text input control 302, condition selection control 304, action selection control 306, and rule description 308. The user may modify various attributes of the rule and then save it to overwrite the existing rule.

Returning to FIG. 2, at 208, the gaming deposit account and its rules are established. This operation may include authorizing or validating that the deposit account is active, establishing or activating an account number, transmitting an electronic record of the account policies (e.g., terms and conditions) to the principal user, providing notice to one or more beneficiary users, or the like. After the account is activated, the principal user may continue to add, modify, or remove rules controlling the use of the gaming deposit account. The principal user may also add, modify, or remove beneficiary users of the gaming deposit account.

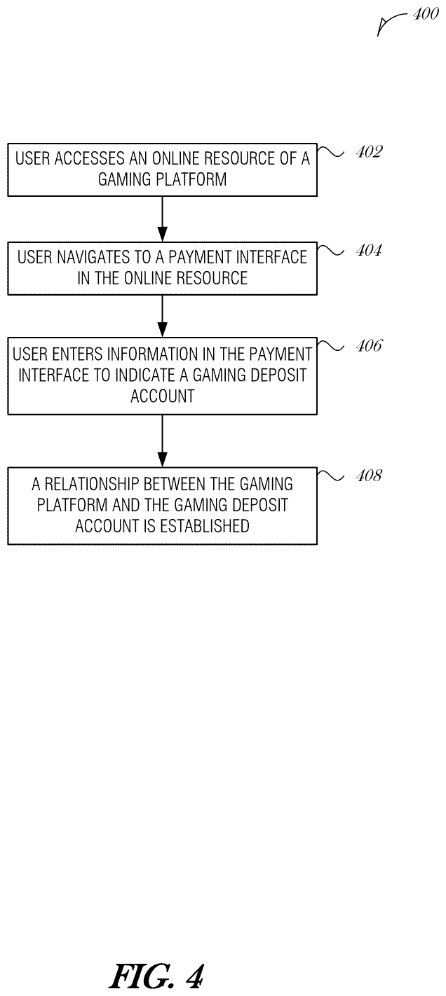

FIG. 4 is a flowchart illustrating a process 400 for establishing a relationship between a gaming platform and a gaming deposit account, according to an embodiment. At 402, a user accesses an online resource of a gaming platform. The online resource may be a website, mobile app, a game, or the like. At 404, the user navigates to a payment interface in the online resource. The payment interface provides the user the ability to enter and store payment information to be used with various purchases through the gaming platform. The payment interface may be an interface presented during a checkout process. Alternatively, the payment interface may be a section of an online account where the user is able enter and save payment sources for convenient access during later checkout processes.

At 406, the user enters information in the payment interface to indicate a gaming deposit account. The information may be in various formats depending on the implementation of the gaming deposit account. For instance, the gaming deposit account may have a corresponding debit card, which is issued by a payment network (e.g., VISA). The debit card may only be usable to withdraw funds from the gaming deposit account. By using a card number, the gaming platform may initiate a payment transaction using the corresponding payment network, similar to how a credit card may be processed, but to debit the gaming deposit account.

In another implementation, the gaming deposit account may have an account number and a routing number. Using the account number and the routing number, the user is able to create a link between the gaming platform and the issuing bank to withdraw (or even deposit) funds from the gaming deposit account. Test deposits may be used by the gaming platform to establish the link between the gaming platform's acquiring bank account and the gaming deposit account.

At 408, a relationship between the gaming platform and the gaming deposit account is established. The gaming platform may draw on the gaming deposit account when the user makes purchases from the gaming platform. Additionally, the gaming platform may also deposit funds into the gaming deposit account based on various activities performed by the user.

For instance, the user may obtain or earn rewards from the gaming platform (e.g., by participating in contests, accruing points, etc.). The rewards may be cashed out as real-world currency and deposited into the gaming deposit account. As another example, the user may cash out the in-game currency to real-world currency. The gaming platform may provide this as a way to incentive players to play more. The exchange rate for in-game currency to real-world currency may fluctuate depending on market factors, time of year, amount converted, etc. As such, purchasing in-game currency with real-world currency, or selling in-game currency for real-world currency represents an exchange rate or conversion rate from one currency to the other. The exchange rates may be presented to the user, which provides insight into how real financial currency markets operate.

For instance, in Fortnite®, which is produced by Epic Games, Inc., the in-game currency is “V-Bucks. ” The V-Bucks are purchasable in various quantities. Typically, the cost of the V-Bucks decrease on a per-unit basis as the quantity of V-Bucks are increased. For example, 1000 V-Bucks may cost $8.99 USD and 5000 V-Bucks may cost $34.99, which represents a substantial decrease in the cost per V-Buck.

In-game assets may be offered at a lower cost (e.g., a sale) for different events, such as at the launch of a new expansion, for a holiday, for a season (e.g., summer league or back-to-school), or the like. During these sales or reduced pricing events, the currency exchange rate changes.

This exchange rate may be displayed along with other exchange rates for other gaming platforms. For example, a list of gaming platforms and their corresponding exchange rates may be displayed in a table in a user interface. A visual indicator (e.g., displaying a list of exchange rates and using green text for an increase in an exchange rate and red text for a decrease in exchange rate).

For background, payment networks are used between a merchant, who holds a merchant account identified by a merchant ID (MID) with an acquiring bank. The merchant offers a product (e.g., in-game currency) for sale at some price. A buyer (e.g., user) holding a credit card, debit card, or providing some other payment account credential, who wishes to purchase the product supplies billing details to the merchant at a checkout. The payment network then initiates the creation of an order, at which point the price is finalized and frozen. This may include transaction fees, such as local or federal sales tax, payment network fees, shipping fees, handling fees, or the like. The purchase account details are submitted to the payment network via a payment gateway. The payment gateway submits the transaction to the payment network for authorization via a secure financial telecom network (e.g., Visa's is called VisaNet and Mastercard's is called BankNet) using the ISO 8583 protocol. The authorization request is routed to the card issuer or issuing bank who decided whether to permit the account to be debited with the finalized price. Based on various rules, the authorization request may be approved or denied. If permission is granted, then an authorization is issued and sent back to the payment gateway. The payment gateway then informs the merchant that authorization is granted, and the merchant can confirm the order. Once the order is fulfilled, then the merchant can have payment gateway capture the authorization to debit the funds from the issuing bank and credit the funds (less any transaction fees) to the acquiring bank.

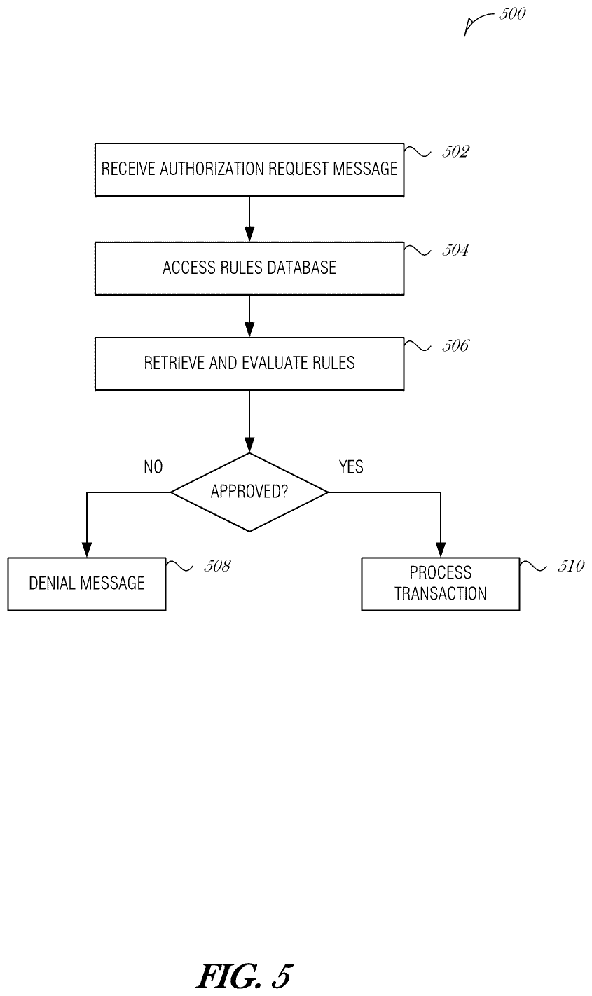

FIG. 5 is a flowchart illustrating a process 500 for processing a transaction from a gaming platform with a gaming deposit account, according to an embodiment. At 502, an authorization request message is received from a payment network, the authorization request message including transaction details for a purchase of an in-game asset through a gaming platform. The transaction details include various details, such as a date and time of the transaction, an amount of the transaction, an identifier of the gaming platform (e.g., name such as “Steam”, code, unique identifier, description, descriptor, etc.), an identifier of the game (e.g., name such as “Call of Duty: Modern Warfare III”, code, description “Call of Duty Series”, unique identifier, descriptor, etc.), an identifier of the in-game asset (e.g., name such as “Call of Duty Points (CP)”, code, unique identifier, description such as “2000 CP”, descriptor, etc.), a type of the in-game asset (e.g., points, currency, weapons, armor, unlocks, etc.), and the like. The authorization request message may be a part of a payment network authorization process (e.g., as described above) or may be an out-of-band message that is used to obtain authorization from the issuing bank.

At 504, a rules database is accessed. At 506, rules associated with the gaming deposit account are retrieve and evaluated against the transaction details from the authorization request message. As described herein, one or more rules may be applied to evaluate the pending transaction and determine whether to approve or deny the request.

If the authorization request is denied, then at 508, a denial message is transmitted to the payment network in response to the authorization request message. The denial message effectively cancels the transaction.

If the authorization request is approved, then at 510, the payment is processed. An approval message may be transmitted to the payment network in response to the authorization request message. The gaming platform may then complete the transaction, such as by crediting the user's game account a certain number of in-game currency, activating an expansion pack, or the like. The amount of the transaction is debited from the gaming deposit account. Additionally, depending on the configuration of the gaming deposit account, user-defined rules, or other configurations, the gaming customer, accountholder, or other people may be notified using various mechanisms, such as text messages, emails, phone calls, notification in a mobile app, or the like.

Payment processing may also include a calculation of rewards. Rewards may be represented as points, cash, in-game currencies, etc. Rewards may be redeemable for cash, in-game currencies, other reward program points, airline points, credit card points, goods, or services. Rewards may be accumulated and tracked in a separate rewards account. The rewards account may be shared among one or more game accounts or other financial accounts.

Periodically, an account statement may be produced by the issuing bank. This account statement may be an electronic document (e.g., email) or a physical document (e.g., paper and post mail). The accountholder (e.g., parent) and account user (e.g., child) may review the account statements to gain a better understanding of purchase history and activity, reward account activity, exchange rates, and the like. Additionally, or alternatively, transaction data, exchange rate data, and other account information may be provided in an app (e.g., a banking mobile app or a web browser), providing up-to-date information for the accountholder or account users to view.

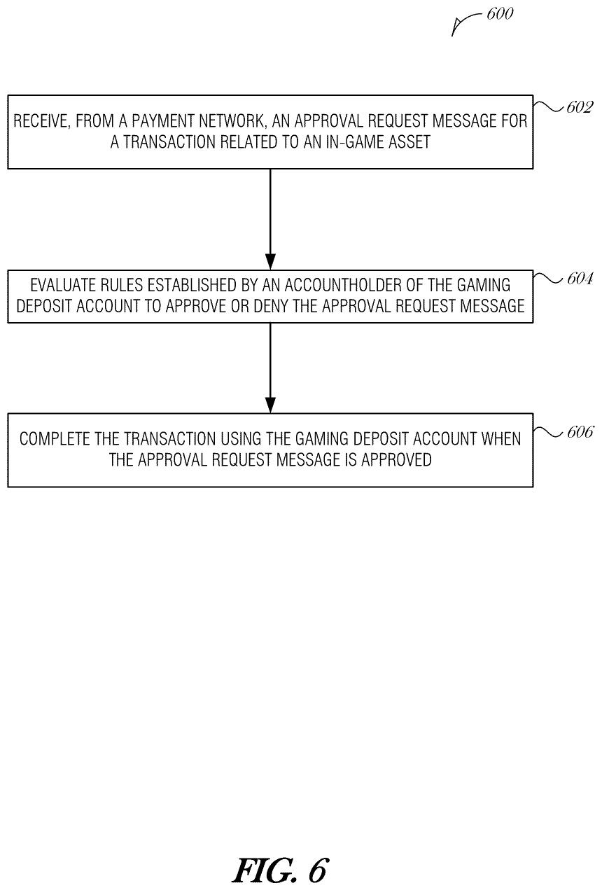

FIG. 6 is a flowchart illustrating a method 600 for processing a transaction for a gaming deposit account at an issuing bank, according to an embodiment. The method 600 may be performed by an electronic system (e.g., issuer bank 102) or any of the modules, logic, circuits, processors, or components described herein.

At 602, the method 600 includes the operation of receiving, from a payment network, an approval request message for a transaction related to an in-game asset. In embodiments, the payment network is a credit card payment network.

In an embodiment, the gaming deposit account is established as a subsidiary account to a primary account at the issuing bank held by the accountholder. In an embodiment, the accountholder is a guardian of a user of the gaming deposit account. In an embodiment, the gaming deposit account is configured to only process transactions with approved gaming platforms. In a further embodiment, the approved gaming platforms are provided by the accountholder. In another embodiment, the approved gaming platforms are provided by the issuing bank.

At 604, the method 600 includes the operation of evaluating rules established by an accountholder of the gaming deposit account to approve or deny the approval request message. In an embodiment, the rules are stored in a rules database. In an embodiment, the rules are configured by the accountholder.

At 606, the method 600 includes the operation of completing the transaction using the gaming deposit account when the approval request message is approved.

In an embodiment, the transaction includes a purchase amount, and the rules to evaluate whether to approve or deny the approval request message are based on the purchase amount.

In an embodiment, the transaction includes a gaming platform identifier, and the rules to evaluate whether to approve or deny the approval request message are based on the gaming platform identifier.

In an embodiment, the transaction includes a game identifier, and the rules to evaluate whether to approve or deny the approval request message are based on the game identifier.

In an embodiment, the transaction includes an in-game asset identifier, and the rules to evaluate whether to approve or deny the approval request message are based on the in-game asset identifier.

In an embodiment, to complete the transaction, the method 600 includes calculating a rewards bonus for the transaction and applying the rewards bonus to a rewards account related to the gaming deposit account.

In an embodiment, the transaction includes a purchase amount and an in-game asset identifier, and to complete the transaction, the method 600 includes calculating an exchange rate based on the purchase amount and the in-game asset identifier and presenting the exchange rate to the accountholder.

In an embodiment, the transaction includes a sale amount and an in-game asset identifier, the sale amount being an amount an in-game asset identified by the in-game asset identifier was sold for, and to complete the transaction, the method 600 includes crediting the gaming deposit account an amount based on the sale amount. In a further embodiment, the method 600 includes calculating a rewards bonus for the transaction and applying the rewards bonus to a rewards account related to the gaming deposit account.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

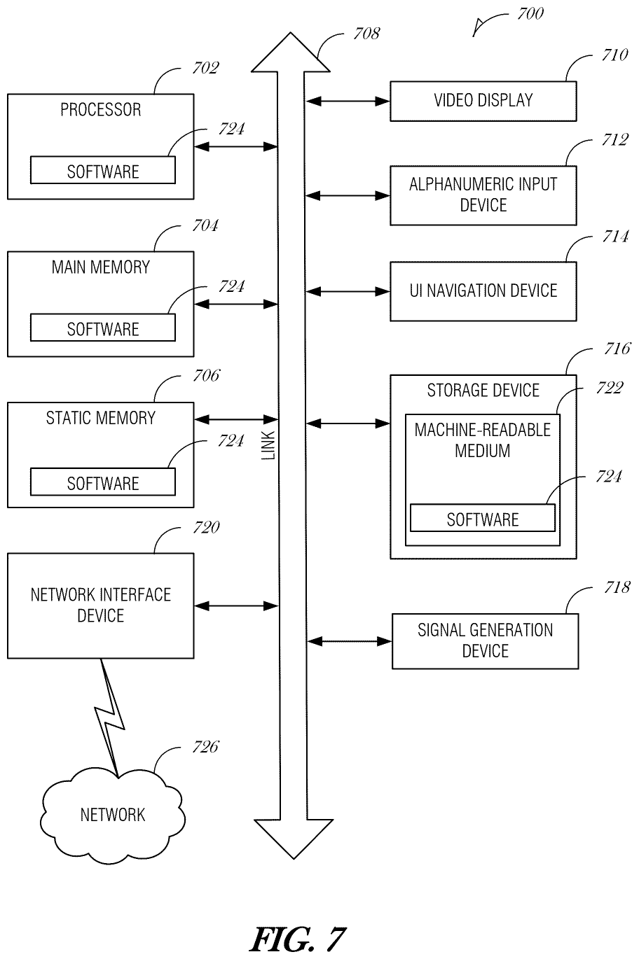

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a system for processing a transaction for a gaming deposit account at an issuing bank, the system comprising: a processor subsystem; and memory including instructions, which when executed by the processor subsystem, cause the processor subsystem to: receive, from a payment network, an approval request message for a transaction related to an in-game asset; evaluate rules established by an accountholder of the gaming deposit account to approve or deny the approval request message, wherein the transaction includes, a gaming platform identifier, a game identifier, or an in-game asset identifier, and wherein the rules to evaluate whether to approve or deny the approval request message are based on the gaming platform identifier, the game identifier, or the in-game asset identifier; and complete the transaction using the gaming deposit account when the approval request message is approved.

In Example 2, the subject matter of Example 1 includes, wherein the payment network is a credit card payment network.

In Example 3, the subject matter of Examples 1-2 includes, wherein the gaming deposit account is established as a subsidiary account to a primary account at the issuing bank held by the accountholder.

In Example 4, the subject matter of Examples 1-3 includes, wherein the accountholder is a guardian of a user of the gaming deposit account.

In Example 5, the subject matter of Examples 1-4 includes, wherein the gaming deposit account is configured to only process transactions with approved gaming platforms.

In Example 6, the subject matter of Example 5 includes, wherein the approved gaming platforms are provided by the accountholder.

In Example 7, the subject matter of Examples 5-6 includes, wherein the approved gaming platforms are provided by the issuing bank.

In Example 8, the subject matter of Examples 1-7 includes, wherein the rules are stored in a rules database.

In Example 9, the subject matter of Examples 1-8 includes, wherein the rules are configured by the accountholder.

In Example 10, the subject matter of Examples 1-9 includes, wherein the transaction includes a purchase amount, and wherein the rules to evaluate whether to approve or deny the approval request message are based on the purchase amount.

In Example 11, the subject matter of Examples 1-10 includes, wherein to complete the transaction, the instructions cause the processor subsystem to: calculate a rewards bonus for the transaction; and apply the rewards bonus to a rewards account related to the gaming deposit account.

In Example 12, the subject matter of Examples 1-11 includes, wherein the transaction includes a purchase amount and an in-game asset identifier, and wherein to complete the transaction, the instructions cause the processor subsystem to: calculate an exchange rate based on the purchase amount and the in-game asset identifier; and present the exchange rate to the accountholder.

In Example 13, the subject matter of Examples 1-12 includes, wherein the transaction includes a sale amount and an in-game asset identifier, the sale amount being an amount an in-game asset identified by the in-game asset identifier was sold for, and wherein to complete the transaction, the instructions cause the processor subsystem to credit the gaming deposit account an amount based on the sale amount.

In Example 14, the subject matter of Example 13 includes, wherein the instructions cause the processor subsystem to: calculate a rewards bonus for the transaction; and apply the rewards bonus to a rewards account related to the gaming deposit account.

Example 15 is a method for processing a transaction for a gaming deposit account at an issuing bank, the method performed on an electronic online system, the method comprising: receiving, from a payment network, an approval request message for a transaction related to an in-game asset; evaluating rules established by an accountholder of the gaming deposit account to approve or deny the approval request message, wherein the transaction includes, a gaming platform identifier, a game identifier, or an in-game asset identifier, and wherein the rules to evaluate whether to approve or deny the approval request message are based on the gaming platform identifier, the game identifier, or the in-game asset identifier; and completing the transaction using the gaming deposit account when the approval request message is approved.

In Example 16, the subject matter of Example 15 includes, wherein the payment network is a credit card payment network.

In Example 17, the subject matter of Examples 15-16 includes, wherein the gaming deposit account is established as a subsidiary account to a primary account at the issuing bank held by the accountholder.

In Example 18, the subject matter of Examples 15-17 includes, wherein the accountholder is a guardian of a user of the gaming deposit account.

In Example 19, the subject matter of Examples 15-18 includes, wherein the gaming deposit account is configured to only process transactions with approved gaming platforms.

In Example 20, the subject matter of Example 19 includes, wherein the approved gaming platforms are provided by the accountholder.

In Example 21, the subject matter of Examples 19-20 includes, wherein the approved gaming platforms are provided by the issuing bank.

In Example 22, the subject matter of Examples 15-21 includes, wherein the rules are stored in a rules database.

In Example 23, the subject matter of Examples 15-22 includes, wherein the rules are configured by the accountholder.

In Example 24, the subject matter of Examples 15-23 includes, wherein the transaction includes a purchase amount, and wherein the rules to evaluate whether to approve or deny the approval request message are based on the purchase amount.

In Example 25, the subject matter of Examples 15-24 includes, wherein completing the transaction comprises: calculating a rewards bonus for the transaction; and applying the rewards bonus to a rewards account related to the gaming deposit account.

In Example 26, the subject matter of Examples 15-25 includes, wherein the transaction includes a purchase amount and an in-game asset identifier, and wherein completing the transaction comprises: calculating an exchange rate based on the purchase amount and the in-game asset identifier; and presenting the exchange rate to the accountholder.

In Example 27, the subject matter of Examples 15-26 includes, wherein the transaction includes a sale amount and an in-game asset identifier, the sale amount being an amount an in-game asset identified by the in-game asset identifier was sold for, and wherein completing the transaction comprises crediting the gaming deposit account an amount based on the sale amount.

In Example 28, the subject matter of Example 27 includes, calculating a rewards bonus for the transaction; and applying the rewards bonus to a rewards account related to the gaming deposit account.

Example 29 is a non-transitory machine-readable medium comprising instructions for processing a transaction for a gaming deposit account at an issuing bank, which when executed by a machine in an online system cause the machine to: receive, from a payment network, an approval request message for a transaction related to an in-game asset; evaluate rules established by an accountholder of the gaming deposit account to approve or deny the approval request message, wherein the transaction includes, a gaming platform identifier, a game identifier, or an in-game asset identifier, and wherein the rules to evaluate whether to approve or deny the approval request message are based on the gaming platform identifier, the game identifier, or the in-game asset identifier; and complete the transaction using the gaming deposit account when the approval request message is approved.

In Example 30, the subject matter of Example 29 includes, wherein the payment network is a credit card payment network.

In Example 31, the subject matter of Examples 29-30 includes, wherein the gaming deposit account is established as a subsidiary account to a primary account at the issuing bank held by the accountholder.

In Example 32, the subject matter of Examples 29-31 includes, wherein the accountholder is a guardian of a user of the gaming deposit account.

In Example 33, the subject matter of Examples 29-32 includes, wherein the gaming deposit account is configured to only process transactions with approved gaming platforms.

In Example 34, the subject matter of Example 33 includes, wherein the approved gaming platforms are provided by the accountholder.

In Example 35, the subject matter of Examples 33-34 includes, wherein the approved gaming platforms are provided by the issuing bank.

In Example 36, the subject matter of Examples 29-35 includes, wherein the rules are stored in a rules database.

In Example 37, the subject matter of Examples 29-36 includes, wherein the rules are configured by the accountholder.

In Example 38, the subject matter of Examples 29-37 includes, wherein the transaction includes a purchase amount, and wherein the rules to evaluate whether to approve or deny the approval request message are based on the purchase amount.

In Example 39, the subject matter of Examples 29-38 includes, wherein to complete the transaction, the instructions cause the machine to: calculate a rewards bonus for the transaction; and apply the rewards bonus to a rewards account related to the gaming deposit account.

In Example 40, the subject matter of Examples 29-39 includes, wherein the transaction includes a purchase amount and an in-game asset identifier, and wherein to complete the transaction, the instructions cause the machine to: calculate an exchange rate based on the purchase amount and the in-game asset identifier; and present the exchange rate to the accountholder.

In Example 41, the subject matter of Examples 29-40 includes, wherein the transaction includes a sale amount and an in-game asset identifier, the sale amount being an amount an in-game asset identified by the in-game asset identifier was sold for, and wherein to complete the transaction, the instructions cause the machine to credit the gaming deposit account an amount based on the sale amount.

In Example 42, the subject matter of Example 41 includes, wherein the instructions cause the machine to: calculate a rewards bonus for the transaction; and apply the rewards bonus to a rewards account related to the gaming deposit account.

Example 43 is at least one machine-readable medium including instructions that, when executed by processing circuitry, cause the processing circuitry to perform operations to implement of any of Examples 1-42.

Example 44 is an apparatus comprising means to implement of any of Examples 1-42.

Example 45 is a system to implement of any of Examples 1-42.

Example 46 is a method to implement of any of Examples 1-42.

The above detailed description includes references to the accompanying drawings, which form a part of the detailed description. The drawings show, by way of illustration, specific embodiments that may be practiced. These embodiments are also referred to herein as “examples. ” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more. ” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein. ” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for processing a transaction for a gaming deposit account at an issuing bank, the system comprising:
a processor subsystem; and
memory including instructions, which when executed by the processor subsystem, cause the processor subsystem to:
receive, from a payment network, an approval request message for a transaction related to an in-game asset;
evaluate rules established by an accountholder of the gaming deposit account to approve or deny the approval request message, wherein the transaction includes a gaming platform identifier, a game identifier, or an in-game asset identifier, and wherein the rules to evaluate whether to approve or deny the approval request message are based on the gaming platform identifier, the game identifier, or the in-game asset identifier; and
complete the transaction using the gaming deposit account when the approval request message is approved.

2. The system of claim 1, wherein the payment network is a credit card payment network.

3. The system of claim 1, wherein the gaming deposit account is established as a subsidiary account to a primary account at the issuing bank held by the accountholder.

4. The system of claim 1, wherein the accountholder is a guardian of a user of the gaming deposit account.

5. The system of claim 1, wherein the gaming deposit account is configured to only process transactions with approved gaming platforms.

6. The system of claim 5, wherein the approved gaming platforms are provided by the accountholder.

7. The system of claim 5, wherein the approved gaming platforms are provided by the issuing bank.

8. The system of claim 1, wherein the rules are stored in a rules database.

9. The system of claim 1, wherein the rules are configured by the accountholder.

10. The system of claim 1, wherein the transaction includes a purchase amount, and wherein the rules to evaluate whether to approve or deny the approval request message are based on the purchase amount.

11. The system of claim 1, wherein to complete the transaction, the instructions cause the processor subsystem to:
calculate a rewards bonus for the transaction; and
apply the rewards bonus to a rewards account related to the gaming deposit account.

12. The system of claim 1, wherein the transaction includes a purchase amount and an in-game asset identifier, and wherein to complete the transaction, the instructions cause the processor subsystem to:
calculate an exchange rate based on the purchase amount and the in-game asset identifier; and
present the exchange rate to the accountholder.

13. The system of claim 1, wherein the transaction includes a sale amount and an in-game asset identifier, the sale amount being an amount an in-game asset identified by the in-game asset identifier was sold for, and wherein to complete the transaction, the instructions cause the processor subsystem to credit the gaming deposit account an amount based on the sale amount.

14. The system of claim 13, wherein the instructions cause the processor subsystem to:
calculate a rewards bonus for the transaction; and
apply the rewards bonus to a rewards account related to the gaming deposit account.

15. A method for processing a transaction for a gaming deposit account at an issuing bank, the method performed on an electronic online system, the method comprising:
receiving, from a payment network, an approval request message for a transaction related to an in-game asset;
evaluating rules established by an accountholder of the gaming deposit account to approve or deny the approval request message, wherein the transaction includes a gaming platform identifier, a game identifier, or an in-game asset identifier, and wherein the rules to evaluate whether to approve or deny the approval request message are based on the gaming platform identifier, the game identifier, or the in-game asset identifier; and
completing the transaction using the gaming deposit account when the approval request message is approved.

16. The method of claim 15, wherein the payment network is a credit card payment network.

17. The method of claim 15, wherein the gaming deposit account is established as a subsidiary account to a primary account at the issuing bank held by the accountholder.

18. The method of claim 15, wherein the accountholder is a guardian of a user of the gaming deposit account.

19. The method of claim 15, wherein the gaming deposit account is configured to only process transactions with approved gaming platforms.

20. A non-transitory machine-readable medium comprising instructions for processing a transaction for a gaming deposit account at an issuing bank, which when executed by a machine in an online system cause the machine to:
receive, from a payment network, an approval request message for a transaction related to an in-game asset;
evaluate rules established by an accountholder of the gaming deposit account to approve or deny the approval request message, wherein the transaction includes a gaming platform identifier, a game identifier, or an in-game asset identifier, and wherein the rules to evaluate whether to approve or deny the approval request message are based on the gaming platform identifier, the game identifier, or the in-game asset identifier; and
complete the transaction using the gaming deposit account when the approval request message is approved.
